(19) United States
(12) Patent Application Publication
(10) Pub. No.: US 2025/0276450 A1
(43) Pub. Date: Sep. 4, 2025

(54) METHOD AND SYSTEM FOR PROGRAMMING AN INDUSTRIAL ROBOT

(71) Applicant: ABB SCHWEIZ AG, Baden (CH)

(72) Inventors: Ye Tian, Shanghai (CN); Huiming WANG, Shanghai (CN)

(21) Appl. No.: 19/214,236

(22) Filed: May 21, 2025

Related U.S. Application Data
(63) Continuation of application No. PCT/CN2022/133229, filed on Nov. 21, 2022.

(51) Int. Cl. B25J 9/16; B25J 19/06

(52) U.S. Cl. CPC B25J 9/1697; B25J 9/1661; B25J 19/061

(57) ABSTRACT

A method includes acquiring posture data of a tool model moved by a user around a workpiece to be processed, the tool model being held by the user without being held by the robot. The method includes determining reachability of the posture data by the robot and generating, based on reachable posture data, executable code which is to be executed by the robot to process the workpiece via a real tool held by the robot.

### FIELD

Embodiments of the present disclosure generally relate to an industrial robot, and a method and a system for programming the industrial robot.

### BACKGROUND

Industrial robots are widely used in industries. The industrial robots typically comprise a robotic arm having a plural of joints and a controller programmed to control actions of the robotic arm. Because of the complexity of robot programming, it is difficult for small and medium sized enterprises to invest in robotics. It is curial to develop a programming method which facilitates for craftsmen to transfer their skills to programs for industrial robots. A technique called lead-through programming has been widely recognized as a very convenient way of programming robots. During lead-through programming, the programmer moves the tool or work object mounted on the robot by hand to positions along the robot path to be programmed, and records the motions into a memory in the robot controller.

A problem with this method is that the tool has to be mounted on the robot which is further moved by the user. In many cases, the tool and the robotic arm are very heavy and not easy to move. In this case, it is difficult to use the lead-through programming method. In some other cases, the industrial robots operate in an industrial field which prevents the user from accessing the industrial robots due to safety reasons. In this case, the lead-through programming method cannot be used. Thus, there is a need to improve the method for robotics programming.

### SUMMARY

Example embodiments of the present disclosure provide a method and a system for programming the industrial robot which can simplify robotics programming.

In a first aspect of the present disclosure, it is provided a method for programming an industrial robot. The method comprises: acquiring posture data of a tool model moved by a user around a workpiece to be processed, the tool model being held by the user without being held by the robot; determining reachability of the posture data by the robot; and generating, based on reachable posture data, executable codes which is to be executed by the robot to process the workpiece via a real tool held by the robot. According to the present disclosure, during robotics programming, since the tool model is moved by the user without being attached to a robotic arm, the programming process is of higher efficiency compared to the lead through programming robotics without compromising performances. By determining reachability of the posture data by the robot, the user's movement can be guided to avoid the user's movement beyond the reach for the robot.

In some embodiments, acquiring the posture data of the tool model may comprise: receiving the posture data of the tool model from a posture tracker configured to capture the posture data; acquiring a transfer matrix between a tool model coordinate system and a robot coordinate system; and converting the posture data from the tool model coordinate system to the robot coordinate system by the transfer matrix. As such, the posture data captured by the posture tracker can be used for mathematical calculation in conjunction with the robot.

In some embodiments, the method may further comprise: during movement of the tool model, sending a first alarm instruction in real time once it is determined that the posture data cannot be reached by the robot, the first alarm instruction comprising at least one of visible, audible, and tactile alarm instructions. In this way, once the posture data cannot be reached by the robot, the user is warned. The user can be well guided so as to control the posture of the tool model properly.

In some embodiments, the method may further comprise during movement of the tool, sending a second alarm instruction different from the first alarm instruction in real time once it is determined that a difference between the captured posture data differs from posture data that the robot can reach by a predetermined threshold value. In this way, even if the posture data can be reached by the robot but is close to a posture data that cannot be reached by the robot, the user is warned before the posture comes a posture that cannot be reached by the robot and then the user can adaptively change strategy for moving the tool model so as to avoid the posture beyond reach for the robot. The user can be well guided during robotics programming so as to control the posture of the tool model properly.

In some embodiments, the visible alarm instructions may be sent to a display and/or a lamp, the audible alarm instructions are sent to a buzzer or a speaker, and the tactile alarm instructions are sent to a tactile actuator. In this way, the user can be warned properly.

In some embodiments, determining reachability of the posture data by the robot may comprise: acquiring structural characteristics of the robot; determining, based on the structural characteristics of the robot and the posture data of the tool model in robot coordinates, whether an angle of a joint of the robot has a solution by using Inverse Kinematics; and sending an alarm instruction in real time once it is determined that the angle of the joint of the robot has no solution. In this way, the tool model can be moved over a large area as long as the robot can reach this area. The freedom for the user's movement can be maximized.

In some embodiments, the method may further comprise: determining whether the solution is a singularity when it is determined that the angle of the joint of the robot has a solution; and sending an alarm instruction in real time once it is determined that the solution is a singularity. In this way, the singularity for the joints can be avoided.

In some embodiments, obtaining structural characteristics of the robot may comprise: acquiring D-H parameters of the robot and limit angles of joints of the robot.

In some embodiments, the method may further comprise: determining, based on D-H parameters of the robot and/or limit angles of the joints, a boundary value that can be reached by the robot, the boundary value comprising a furthest distance that the robot can reach, a maximum angle and/or a minimum angle that the joint of the robot can achieve; and generating an alarm instruction which changes in terms of strength or frequency based on a proximity degree of the posture data to the boundary value. In this way, the guidance for guiding the users' movement of the tool model can be further improved.

In some embodiments, determining the reachability of the posture data by the robot may comprise: acquiring D-H parameters of the robot and limit angles of the joints of the robot; determining, based on the D-H parameters and the limit angles of the joints, a workspace of the robot that the robot can reach; and sending an alarm instruction once it is determined that the tool model is close to and/or out of the workspace. In this way, the user's guidance can be simplified with reduced costs.

In some embodiments, the method may further comprise: sending an alarm instruction which changes in terms of strength or frequency based on a proximity degree of the posture data to a boundary of the workspace. In this way, the user can be warned in a efficient way.

In some embodiments, the posture data comprises position data and orientation data.

In a second aspect of the present disclosure, it is provided a system for programming an industrial robot. The system comprise: a posture tracker configured to capture posture data of a tool model moved by a user around a workpiece to be processed; and a processor configured to perform the method according to any of claims 1-12.

In some embodiments, the system may further comprise an alarm device connected to the processor and configured to send alarms in response to an alarm instruction indicating reachability of the posture data by the robot from the processor, the alarm device comprising at least one of a display, a lamp, a buzzer, a speaker, and a tactile actuator.

In a third aspect of the present disclosure, it is provided a computer program product being tangibly stored on a computer readable storage medium and comprising instructions which, when executed on at least one processor, cause the at least one processor to perform the method according to any of the first aspect.

### DESCRIPTION OF DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, wherein:

FIG. 1 is a schematic view showing operation of an industrial robot to be programmed;

FIG. 2 is a schematic view showing a system for programming the industrial robot of FIG. 1 according to one example embodiment of the present disclosure;

FIG. 3 illustrates a flowchart of a method for programming an industrial robot according to one example embodiment of the present disclosure;

FIG. 4 is a block view of the system for programming an industrial robot according to one example embodiment of the present disclosure

FIG. 5 illustrates a flowchart of a method for programming an industrial robot according to another example embodiment of the present disclosure;

FIG. 6 illustrates a flowchart of a method for programming an industrial robot according to yet another example embodiment of the present disclosure;

FIG. 7 is a schematic view showing operation of an industrial robot to be programmed.

FIG. 8 is a schematic view showing a system for programming the industrial robot of FIG. 7 according to another example embodiment of the present disclosure;

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

The term “comprises” or “includes” and its variants are to be read as open terms that mean “includes, but is not limited to.” The term “or” is to be read as “and/or” unless the context clearly indicates otherwise. The term “based on” is to be read as “based at least in part on.” The term “being operable to” is to mean a function, an action, a motion or a state that can be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

Unless specified or limited otherwise, the terms “mounted,” “connected,” “supported,” and “coupled” and variations thereof are used broadly and encompass direct and indirect mountings, connections, supports, and couplings. Furthermore, “connected” and “coupled” are not restricted to physical or mechanical connections or couplings. In the description below, like reference numerals and labels are used to describe the same, similar or corresponding parts in the Figures. Other definitions, explicit and implicit, may be included below.

Lead-through programming method for the robot indeed improves the programming efficiency. However, as mentioned above, this method is not usable in many application scenarios. For example, the industrial robots are inaccessible for the user in the industrial field, for example, due to safety reasons, robots collision. The present disclosure proposes a novel method which obviates a necessity of user's access to the robotic arm, with improved programming efficiency. Through the following detailed descriptions with reference to the accompanying drawings, the above features and advantages of the example embodiments disclosed herein will become more comprehensible.

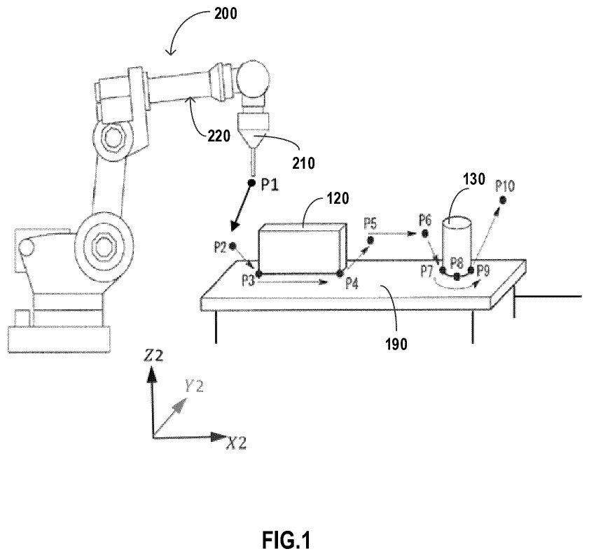

FIG. 1 shows an industrial robot 200 to be programmed and the industrial robot 200 may be arranged in an industrial field to process workpieces 120, 130. As shown in FIG. 1, the robot 200 comprises a robotic arm 220 and a real tool 210 attached to the robotic arm 220. The workpieces 120, 130 are placed on a worktable 190. The robot 200 is configured to execute codes in a controller of the robot 200 to control movements of the robotic arm 220 along a programmed path so that the tool 210 can processes the workpieces automatically. In the shown example, two workpieces 120, 130 are placed on the worktable 190 and are to be processed. For processing the workpiece 120, the tool 210 should take a posture adapted to process the workpieces as required and follow a path, for example, as indicated by the arrows P1 to P5. Likewise, for processing the workpiece 130, the tool should take a posture and follow the path, for example, as indicated by the arrows P6 to P10. It is to be understood that the workpieces 130 is shown merely for sake of comparison. The path as indicated by the arrows P6 to P9 is actually beyond reachability of the robot 200.

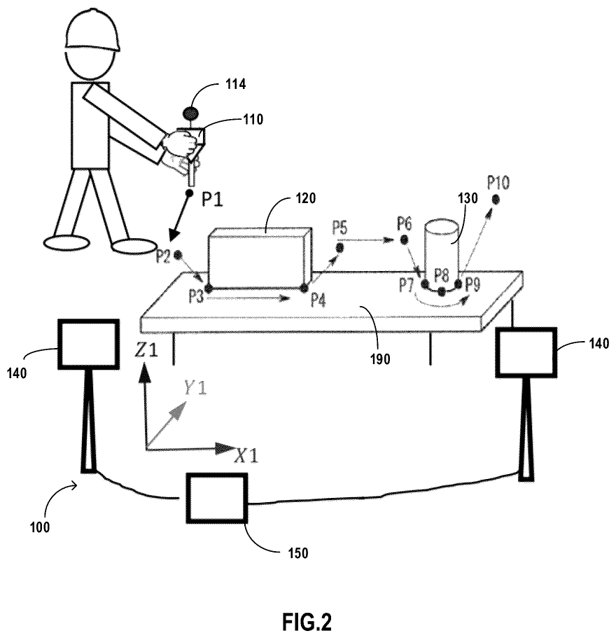

FIG. 2 shows a system 100 for programming the industrial robot 200 according to one example embodiment of the present disclosure. As shown in FIG. 2, the system for programming the industrial robot 200 comprises a tool model 110, a posture tracker 140 configured to capture posture data of the tool model 110, and a processor 150 configured to covert the posture data to processor-executable codes.

In the system of the present disclosure, completely different from the lead through programming method, the tool model 110 is not attached to a robotic arm 220 of the industrial robot 200 but is directly moved a user, for example a skilled engineer. The tool model 110 may be of various forms. In some example, the tool model 110 may be real tool for processing the workpiece. In some example, the tool model may just be a model for programming and may be of any proper shapes. During the programming process, the user can grip the tool model 110 and move the tool model 110 around a workpiece to be processed 120 along a path which is proper for processing the workpiece. The path is generally determined by the skilled engineer. In the shown example, the tool is directly moved by the user. In some example, the tool can be moved by a gripper carried by the user. The tool model may be of various types according to the processing types of the workpiece.

The posture tracker 140 is configured to capture posture data of the tool model 110 moved by the user. Typically, the posture data may comprise position data. The position data indicates the position of the tool in the robotic system. With the position data, the path followed by the tool can be formed. In some examples, the posture data may comprise orientation data. The orientation data indicates the orientation of the tool. The posture tracker 140 may take various forms as long as the posture tracker 140 can track or acquire the posture data of the tool model 110. In the shown example, one or two track stations 140 are arranged at a proper position of the worktable 190 for capturing posture data of the tool model 110 when being moved by the use, for example, at a side of the worktable 190. In some embodiments, the track station 140 alone can capture posture data of the tool model 110. Alternatively or in addition, a position sensor or a detectable marker may be provided on/in the tool model 110. In this way, the posture data can be more accurately acquired. It is to be understood that this tracking arrangement is merely illustrative. In some other embodiments, for example, the track station may be arranged on the tool model 110 and various tracking methods can be used to determine the posture data of the tool model 110 moved by the user.

The processor 150 is connected to the posture tracker 140. The posture data captured by the posture tracker 140 can be sent to the processor 150 in real time. The processor 150 is configured to convert the posture data of the tool model 110 into computer-executable codes which can be loaded into the controller of the industrial robot 200. When the controller of the industrial robot 200 loaded by the computer-executable instructions, the robot 200 can automatically process the workpiece by execution of the programmed codes.

As mentioned above, in the novel robotics programming method of the present disclosure, the tool model is moved freely by the user and is not limited by the robot system 20. Since the tool model is not attached by the robotic arm, there is a high risk that the tool model is moved beyond a reach area of the robot system 200. The user has no idea whether the path or the orientation of the tool model is reachable for the robot or not. If the program codes include path points or orientation which cannot be reached by the robot, the codes cannot be directly used by the robot 200. For example, as shown in FIG. 2, when the user moves the tool model to the points P6-P10, the generated program codes cannot be excitable by the robot which needs addition manual involved modification before use. This is not designed since this increases the programming workloads and programming complexity. There is need to guide the user's movement so that the user's movement do not goes beyond the reachability of the robot 200.

In the present disclosure, the processor 150 is configured to analyze the acquired posture data from the posture tracker 140 and to determine reachability of the posture data by the robot 200. When the acquired posture data is determined to be reachable by the robot, the program codes can be loaded to the robot 200 for execution. In this way, the risk that the generated program codes cannot be directly used is avoided.

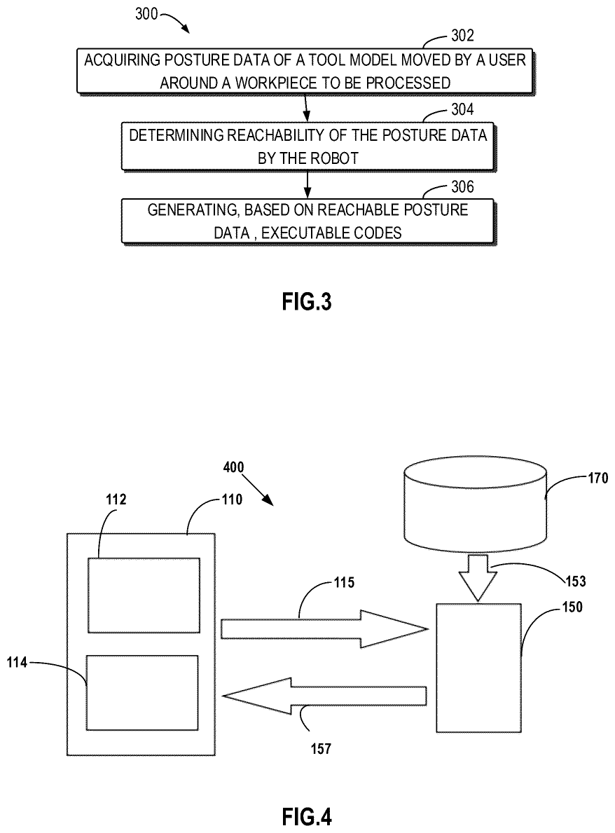

FIG. 3 illustrates a flowchart of a method 300 for programming an industrial robot according to one example embodiment of the present disclosure. As shown in FIG. 3, the method 300 comprises the following actions. At block 302, posture data 115 of a tool model 110 moved by a user around a workpiece to be processed 120 is acquired. The tool model 110 is held by the user without being held by the robot 200. At block 304, reachability of the posture data 115 by the robot 200 is determined. At block 306, executable codes are generated based on reachable posture data. The executable codes can be executed by a processor to process the workpiece to be processed 120 via a real tool 210 held by the robot 200.

In some embodiments, the method 300 may further comprise sending an alarm according to the decision result of the posture data. In one embodiment, during movement of the tool model 110, a first alarm instruction 157 is sent in real time once it is determined that the posture data cannot be reached by the robot 200. In this way, according to the first alarm instruction, the user holding the tool model 110 can know that the current posture data cannot be reached. The posture should be adjusted by the user. This is particularly advantageous when the user is initially roughly moving the tool model around the workpiece before carefully moving the tool model. Through the rough movement of the tool model, the user can have a general profile of the safety area (i.e, the area that the robot 200 can surely reach).

In another embodiment, during movement of the tool, a second alarm instruction different from the first alarm instruction 157 in real time is sent once it is determined that a difference between the captured posture data 115 differs from posture data 115 that the robot 200 can reach by a predetermined threshold value. The predetermined threshold value can be determined in advance. By use of the predetermined threshold value, the user holding the tool model 110 can know that although the current posture data can be reached by the robot, it is close to a posture that cannot be reached by the robot. The user should change movement strategy in moving the robot to avoid to assume a posture that cannot be reached by the robot. This is particularly advantageous when the user is finely moving the tool model around the workpiece. Through the fine movement of the tool model, the program codes can be produced efficiently.

In some embodiments, as shown in FIG. 2, an alarm device 114, such as a lighting device, is provided on the tool model 110. The alarm device 114 is configured to produce warning in response to the alarm instructions from the processor. The alarms may be visible, audible, or tactile alarms, or of any other proper forms. In some embodiments, the strength, frequency of the alarm device or the like can change. For example, the lighting device can change color or/or blinking frequency to increase the warning degree for the user. Alternatively or in addition, in some embodiments, a display can be provided on the tool model and is configured to display text, graphic, and the like in response to the visible alarm instructions from the processor. Alternatively or in addition, a buzzer or a speaker may be provided to provide warnings to the user. In some embodiments, a tactile actuator may be provided to produce vibration feedback to the user. It is to be understood that the alarms may be various forms as long as the user can be warned in an efficient way. In the shown example, these warning devices are provided on the tool model. This is advantageous since the user is close to the tool model and can immediately know the movement conditions provided by the warning devices. It is to be understood that the warning devices may be provided any other proper positions.

In some embodiments, the method may further comprise coordinate system conversion. As shown in FIG. 1, the robot system 200 may comprise its own coordinate system X2, Y2, Z2 and the robot system 200 operates based on this coordinate system X2, Y2, Z2. On the other hand, the system 100 for programming the robot operates with its own coordinate system X1, Y1, Z1. The captured posture data thus is represented with coordinate system. In this event, in order to determine reachability of the posture data by the robot 200, the posture data should be converted to the robotic coordinate system. In some embodiments, a transfer matrix between a tool model coordinate system and a robot coordinate system is obtained. The posture data 115 from the tool model coordinate system may be converted to the robot coordinate system by the transfer matrix.

FIG. 4 is a block view of the system 400 for programming an industrial robot according to one example embodiment of the present disclosure. As shown in FIG. 4, the system 100 may comprise a tool model 110, a memory 170, and a processor 150 communicatively connected to the tool model 110 and the memory 170. The tool model 110 comprises a posture tracker 112 and an alarm device 114 configured to produce alarms. The posture tracker 112 may operate alone or in combination with other devices to track the posture of the tool model 110. The memory 170 may store structural characteristics 153 of the robot 200 in advance. In some embodiments, these structural characteristics 153 comprise D-H parameters of the robot 200. In other embodiments, the structural characteristics 153 comprise limit angles of joints of the robot 200. This is merely illustrative, and the memory 170 may comprise other parameters derived from the D-H parameters and the limit angles of the joints of the robot, and the like as long as these parameters can depict the reachability of the robot. The processor 150 is configured to obtain posture data 115 of the tool model 110 and to acquire structural characteristics 153 of the robot 200. The processor 150 is configured to determine reachability of the posture data 115 by the robot 200 based on the structural characteristics 153 of the robot 200. An alarm instruction 157 is sent in real time by the processor based on the determination result.

FIG. 5 illustrates a flowchart of a method 500 for programming an industrial robot according to another example embodiment of the present disclosure. As shown in FIG. 5, at block 502, structural characteristics 153 of the robot 200, such as D-H parameters and limit angles of joints of the robot 200, is obtained. At block 504, it is determined, based on the structural characteristics 153 of the robot 200 and the posture data 115 of the tool model 110, whether an angle of a joint of the robot 200 has a solution by using Inverse Kinematics. At block 506, an alarm instruction 157 is sent in real time once it is determined that the angle of the joint of the robot 200 has no solution. Since the angle of the joint of the robot 200 has no solution, it means that the posture data shown by the tool model cannot be reached.

In some embodiments, when it is determined that the angle of the joint of the robot 200 has a solution, it is determined whether the solution is a singularity. Once it is determined that the solution is a singularity, an alarm instruction 157 is sent in real time. In this way, the singularity in the solution can be excluded.

In some embodiments, a boundary value that can be reached by the robot 200 can be determined based on D-H parameters of the robot 200 and/or limit angles of the joints. The boundary value may comprise a furthest distance that the robot 200 can reach, angle ranges that the joint of the robot 200 can achieve. An alarm instruction 157 can be sent to the alarming device based on a proximity degree of the posture data 115 to the boundary value. In some embodiments, the alarm signals may changes in terms of strength or frequency. In this way, the user can know in real time that the posture is close to the unreachable posture for the robot so that the user can move the tool model in a proper way.

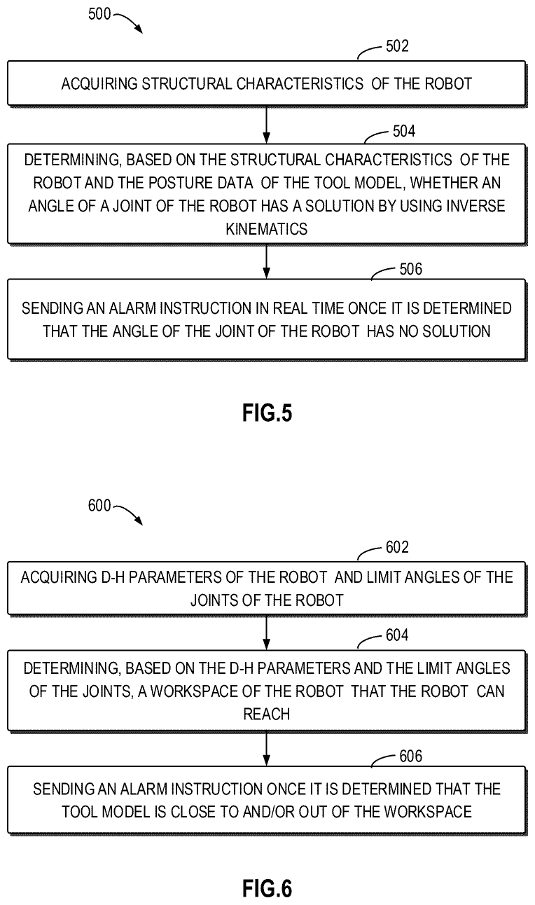

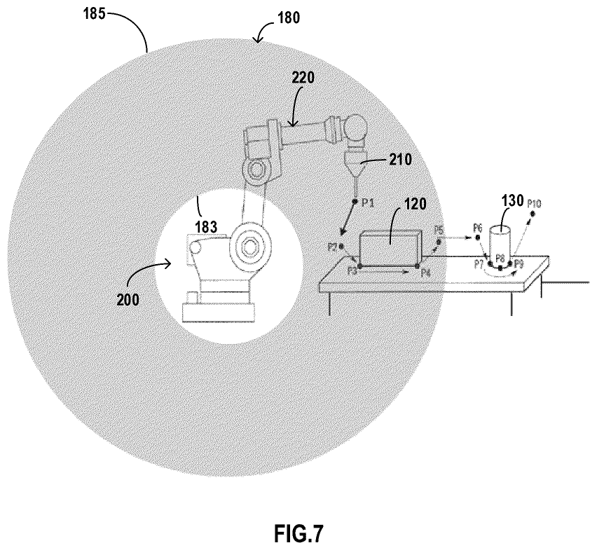

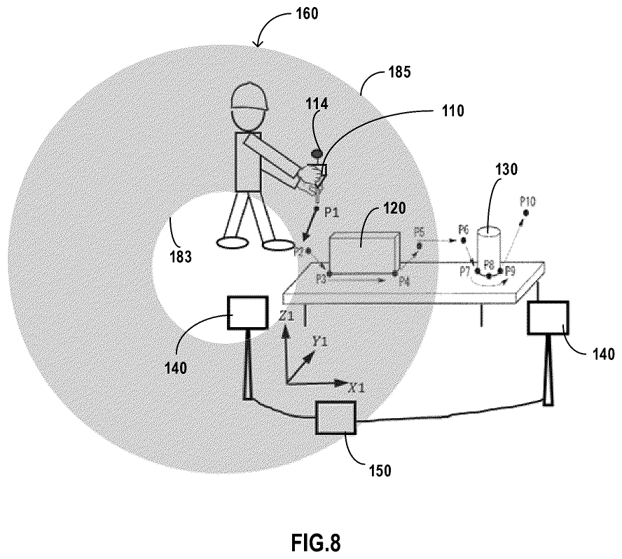

FIG. 6 illustrates a flowchart of a method 600 for programming an industrial robot according to yet another example embodiment of the present disclosure. FIGS. 7 and 8 show schematic views showing operation of the industrial robot to be programmed by the system of FIG. 7 and a system for programming an industrial robot according to another example embodiment of the present disclosure respectively.

As shown in FIG. 6, the method 600 comprises the following actions. When the tool model 110 is moved around an object to be processed, the method 600 is carried out in real time. At block 602, D-H parameters of the robot 200 and limit angles of the joints of the robot 200 are acquired. At block 604, a workspace of the robot 200 that the robot 200 can reach is determined based on the acquired D-H parameters and the limit angles of the joints. The term “workspace” herein refers to an area that the robot 200 can surely reach. When the tool model is within this area, there is no risk to worry about the reachability of the robot. This workspace is determined in advance according to various factors, such as collision within the area, in addition to the structural characteristics of the robot. This workspace is typically smaller than the real area that the robot 200 is designed to reach. At block 606, an alarm instruction 157 is sent once it is determined that the tool model 110 is close to, at, and/or out of a boundary of the workspace.

With this method, by determining a reachable workspace in advance, an alarm is sent in accordance with proximity degree of the posture data 115 to a boundary of the predetermined workspace. In this way, the programming method can also be implemented with high efficacy.

In some embodiments, alarm instructions are changeable in terms of strength and/or frequency based on a proximity degree of the posture data 115 to a boundary of the workspace. For example, when the posture data 115 of the tool model is close to a boundary of the predetermined workspace by a predetermined threshold, an alarm instruction with a lower strength can be sent to the alarm device. The user can know that the user is getting close to risky area. When the posture data 115 of the tool model is further closer to the boundary of the predetermined workspace, the alarm instruction with increased strength can be sent to the alarm device. The user can know that the user is getting closer to risky area and should be careful with movement of the tool model. In some cases, the user should adjust its movement strategy, for example, move the tool model in an opposite direction that prevent the alarm device from alarming. In this way, the user can know that the current tool model is in the area that cannot be reached by the robot. When the posture data 115 of the tool model is at the boundary of the predetermined workspace, the alarm device operates at the maximum strength. On the other hand, when the user is back to the reachable area, the alarm device stops alarming. In this way, the user can know that the current tool model is back to the reachable area again.

In some embodiments, as shown in FIG. 7, the robot 200 comprises a robotic arm 220 and a tool 210 is fixed to the robotic arm 220. Due to the structural limits, the robotic arm 220 can move within a limited area. A workspace 180 is shown as an example. The workspace 180 refers to an area that can be surely reached by the robotic arm 220. When the tool is within this workspace 180, the posture of the tool can be reached. The workspace 180 may be determined in advance before programming in accordance with the structural characteristics of the robot. The workspace 180 may be of any proper shapes. In the shown example, the workspace 180 is in shape of a ring and comprises an inner boundary 183 and an outer boundary 185. It is to be understood that the shape of the workspace 180 is merely illustrative and the shape of the workspace 180 can be of any other proper shapes.

As shown in FIG. 8, there are two workpieces 120 and 130 to be processed on the worktable. A user is carrying a tool model 110. The user moves the tool model 110 around the object to be processed on the worktable. During the movement of the tool model, the posture tracker 140 captures the posture data of the tool model. The processor 150 converts the captured posture data to machine executable codes.

In the shown example, the object 120 is designed to be processed, for example, along the path from P1 to P5 according to experience. The object 130 is designed to be processed, for example, along the path from P6 to P9 according to experience. As shown in FIG. 8, the path for processing the object 120 is located in the reachable workspace 180 while the path for processing the object 130 is located outside the reachable workspace 180. During the programming process, the tool model should be moved within the reachable workspace 180. Once the tool model is close to or at the inner boundary 183 and the outer boundary 185 of the workspace 180, the user should be notified or warned, for example by the alarm device 114 provided on the tool model. On the other hand, when the user is back to the safety area or reachable area, the alarm device stops alarming. In this way, the user can know that the current tool model is back to the reachable area again. By operation of the alarm device 114, the user is prevented from moving the tool model on own will. In this way, the programming efficacy can be improved.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 3, 5, and 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. On the other hand, various features that are described in the context of a single embodiment may also be implemented in multiple embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for programming an industrial robot, comprising:
acquiring posture data of a tool model moved by a user around a workpiece to be processed, the tool model being held by the user without being held by the robot;
determining reachability of the posture data by the robot; and
generating, based on reachable posture data, executable codes which is to be executed by the robot to process the workpiece via a real tool held by the robot.

2. The method of claim 1, wherein acquiring the posture data of the tool model comprises:
receiving the posture data of the tool model from a posture tracker configured to capture the posture data;
acquiring a transfer matrix between a tool model coordinate system and a robot coordinate system; and
converting the posture data from the tool model coordinate system to the robot coordinate system by the transfer matrix.

3. The method of claim 1, further comprising:
during movement of the tool model, sending a first alarm instruction in real time once it is determined that the posture data cannot be reached by the robot, the first alarm instruction comprising at least one of visible, audible, and tactile alarm instructions.

4. The method of claim 3, further comprising:
during movement of the tool, sending a second alarm instruction different from the first alarm instruction in real time once it is determined that a difference between the captured posture data differs from posture data that the robot can reach by a predetermined threshold value.

5. The method of claim 3, wherein the visible alarm instructions are sent to a display and/or a lamp, the audible alarm instructions are sent to a buzzer or a speaker, and the tactile alarm instructions are sent to a tactile actuator.

6. The method of claim 1, wherein determining reachability of the posture data by the robot comprises:
acquiring structural characteristics of the robot;
determining, based on the structural characteristics of the robot and the posture data of the tool model in robot coordinates, whether an angle of a joint of the robot has a solution by using Inverse Kinematics; and
sending an alarm instruction in real time once it is determined that the angle of the joint of the robot has no solution.

7. The method of claim 6, further comprising:
determining whether the solution is a singularity when it is determined that the angle of the joint of the robot has a solution; and
sending an alarm instruction in real time once it is determined that the solution is a singularity.

8. The method of claim 6, wherein obtaining structural characteristics of the robot comprises:
acquiring D-H parameters of the robot and limit angles of joints of the robot.

9. The method of claim 8, further comprising:
determining, based on D-H parameters of the robot and/or limit angles of the joints, a boundary value that can be reached by the robot, the boundary value comprising a furthest distance that the robot can reach, a maximum angle and/or a minimum angle that the joint of the robot can achieve; and
generating an alarm instruction which changes in terms of strength or frequency based on a proximity degree of the posture data to the boundary value.

10. The method of claim 1, wherein determining the reachability of the posture data by the robot comprises:
acquiring D-H parameters of the robot and limit angles of the joints of the robot;
determining, based on the D-H parameters and the limit angles of the joints, a workspace of the robot that the robot can reach; and
sending an alarm instruction once it is determined that the tool model is close to and/or out of the workspace.

11. The method of claim 10, further comprising:
sending an alarm instruction which changes in terms of strength or frequency based on a proximity degree of the posture data to a boundary of the workspace.

12. The method according to claim 1, wherein the posture data comprises position data and orientation data.

13. A system for programming an industrial robot, comprising:
a posture tracker configured to capture posture data of a tool model moved by a user around a workpiece to be processed; and
a processor configured to perform the method according to claim 1.

14. The system according to claim 13, further comprising an alarm device connected to the processor and configured to send alarms in response to an alarm instruction indicating reachability of the posture data by the robot from the processor, the alarm device comprising at least one of a display, a lamp, a buzzer, a speaker, and a tactile actuator.

15. A computer program product being tangibly stored on a computer readable storage medium and comprising instructions which, when executed on at least one processor, cause the at least one processor to perform the method according to claim 1.

16. The method of claim 4, wherein the visible alarm instructions are sent to a display and/or a lamp, the audible alarm instructions are sent to a buzzer or a speaker, and the tactile alarm instructions are sent to a tactile actuator.

17. The method of claim 5, wherein determining reachability of the posture data by the robot comprises:
acquiring structural characteristics of the robot;
determining, based on the structural characteristics of the robot and the posture data of the tool model in robot coordinates, whether an angle of a joint of the robot has a solution by using Inverse Kinematics; and
sending an alarm instruction in real time once it is determined that the angle of the joint of the robot has no solution.

18. The method of claim 7, wherein obtaining structural characteristics of the robot comprises:
acquiring D-H parameters of the robot and limit angles of joints of the robot.

19. The method of claim 9, wherein determining the reachability of the posture data by the robot comprises:
acquiring D-H parameters of the robot and limit angles of the joints of the robot;
determining, based on the D-H parameters and the limit angles of the joints, a workspace of the robot that the robot can reach; and
sending an alarm instruction once it is determined that the tool model is close to and/or out of the workspace.

20. The method according to claim 11, wherein the posture data comprises position data and orientation data.
